(19) United States
(12) Patent Application Publication
(10) Pub. No.: US 2012/0042865 A1
(43) Pub. Date: Feb. 23, 2012

(54) Cooking Fuel Preparation Container

(76) Inventor: Dana Turner, Robbinsdale, MN (US)

(21) Appl. No.: 13/051,828

(22) Filed: Mar. 18, 2011

Related U.S. Application Data
(60) Provisional application No. 61/376,155, filed on Aug. 23, 2010.

(51) Int. Cl. A47J 37/07

(52) U.S. Cl. 126/25 R

(57) ABSTRACT

A cooking fuel preparation device and method of use are described. In one aspect, the device includes a metal enclosure having a bottom, a rear, left and right sides, an open front and an open top, the metal enclosure forming an interior. The device further includes a base attached to the metal enclosure, the base including at least one support, and one or more grate supports mounted to at least the left and right sides within the interior. The device also includes a substantially planar grate positioned on the one or more grate supports and having a plurality of apertures therethrough, the grate angled downwardly toward the rear of the metal enclosure and forming an upper cooking fuel preparation region and a lower ventilation region within the interior volume.

### CROSS REFERENCE TO RELATED APPLICATIONS

The present application claims priority to U.S. Provisional Patent Application No. 61/376,155 filed Aug. 23, 2010, the disclosure of which is hereby incorporated by reference in its entirety.

### TECHNICAL FIELD

The present application relates generally to cooking implements; in particular, the present application relates to a cooking fuel preparation device.

### BACKGROUND

A variety of implements exist that assist in grilling and barbecue cooking Typically, these implements include tools for manipulating the food being cooked. For example, various grilling and barbecuing implements exist for preparing and moving food before or after it is barbecued (e.g., brushes, mops, tongs, spatulas, spits, rotisseries, etc.).

It is equally important to quality grilling or barbecue cooking (collectively referred to herein as “outdoor cooking”) to properly maintain cooking fuel. Specifically, maintaining a steady level of cooking fuel in a barbecue grill allows a cook to be able to rely on that barbecue grill to produce reliable temperatures, and avoid uneven heating.

Although generally a gas grill or direct electric range can produce a more even heat source, many barbecue chefs prefer to use solid fuels, such as charcoal or wood briquettes, wood chips, logs, or other flammable solid fuel source for direct or indirect radiant cooking, rather than a flammable gas (e.g., propane) or direct conduction (e.g., stovetop) cooking This is because many believe that such cooking techniques impart a superior flavor on the barbecued food. However, even in these circumstances, even heating is important.

In traditional outdoor cooking, maintaining a reliable set of coals for outdoor cooking can be difficult, primarily because in such circumstances, over time, the coals will extinguish as they are burned up. A barbecue chef could slowly add additional unlit coals to a barbecue grill to attempt to maintain an even grilling temperature, but adding unlit coals or wood to a hot grill can greatly affect the temperature at the cooking surface (which will cool rapidly when new fuel is added, and eventually heat up to a hotter-than-intended temperature if too much fuel is added).

For these and other reasons, additional implements focusing on providing evenly-burning cooking fuel for outdoor cooking are desired.

### SUMMARY

In accordance with the following disclosure, the above and other issues are addressed by the following:

In a first aspect, a cooking fuel preparation device and method of use is disclosed. The device includes a metal enclosure having a bottom, a rear, left and right sides, an open front and an open top, the metal enclosure forming an interior. The device further includes a base attached to the metal enclosure, the base including at least one support, and one or more grate supports mounted to at least the left and right sides within the interior. The device also includes a substantially planar grate positioned on the one or more grate supports and having a plurality of apertures therethrough, the grate angled downwardly toward the rear of the metal enclosure and forming an upper cooking fuel preparation region and a lower ventilation region within the interior volume.

In a second aspect, a method of preparing cooking fuel using a cooking fuel preparation device is disclosed. The method includes placing cooking fuel onto a grate positioned within a metal enclosure, the metal enclosure having a bottom, a rear, left and right sides, an open front and an open top, the metal enclosure forming an interior, the grate separating the interior of the metal enclosure into an upper cooking fuel preparation region and a lower ventilation region. The method also includes facing the open front in an upwind direction and lighting the cooking fuel. The method further includes turning the metal enclosure to face the open front in an at least partially downwind direction, thereby controlling a supply of oxygen to the lit cooking fuel in the upper cooking fuel preparation region.

In a third aspect, a cooking fuel preparation device includes a metal enclosure having a bottom, a rear, left and right sides, an open front and an open top, the metal enclosure forming an interior. The device includes a base attached to the metal enclosure, the base including a stand tube and a base plate having a cylindrical support extending upward therefrom, and wherein the metal enclosure is pivotally attached to the stand tube by a second cylindrical support mounted to the bottom of the metal enclosure. The device further includes one or more grate supports mounted to at least the left and right sides within the interior. The device also includes a substantially planar grate positioned on the one or more grate supports and having a plurality of apertures therethrough, the grate angled downwardly toward the rear of the metal enclosure and forming an upper cooking fuel preparation region and a lower ventilation region within the interior volume, wherein the grate is angled within the interior of the metal enclosure such that a front edge of the grate is positioned between one inch and two inches above a rear edge of the grate, and at least one handle mounted to an exterior of the metal enclosure.

### BRIEF DESCRIPTION OF THE DRAWINGS

FIG. 1 is a front perspective view of a cooking fuel preparation device, according to a possible embodiment of the present disclosure;

FIG. 2 is a front plan view of the cooking fuel preparation device of FIG. 1;

FIG. 3 is an exploded view of the cooking fuel preparation device of FIG. 1 with the grate removed;

FIG. 4 is a side plan view of the cooking fuel preparation device of FIG. 1;

FIG. 5 is a top plan view of a first grate useable in a cooling fuel preparation device, according to various embodiments of the present disclosure;

FIG. 6 is a top plan view of a second grate useable in a cooling fuel preparation device, according to various embodiments of the present disclosure;

FIG. 7 is a top plan view of a third grate useable in a cooling fuel preparation device, according to various embodiments of the present disclosure;

FIG. 8 is a front perspective view of a cooking fuel preparation device, according to a second possible embodiment of the present disclosure;

FIG. 9 is a rear perspective view of the cooking fuel preparation device of FIG. 8;

FIG. 10 is a side perspective view of the cooking fuel preparation device of FIG. 8; and

FIG. 11 is a dutch oven cooking table having a cooking fuel preparation device integrated therewith, according to a possible embodiment of the present disclosure.

### DETAILED DESCRIPTION

The present disclosure relates generally to a cooking fuel preparation device. The device is configured to receive and easily maintain inflammation of cooking fuels typically used in outdoor cooking applications, including a variety of types and sizes of wood and charcoal fuels. The cooking fuels can be transferred to an outdoor cooking appliance, such as a barbecue grill or pit, as needed.

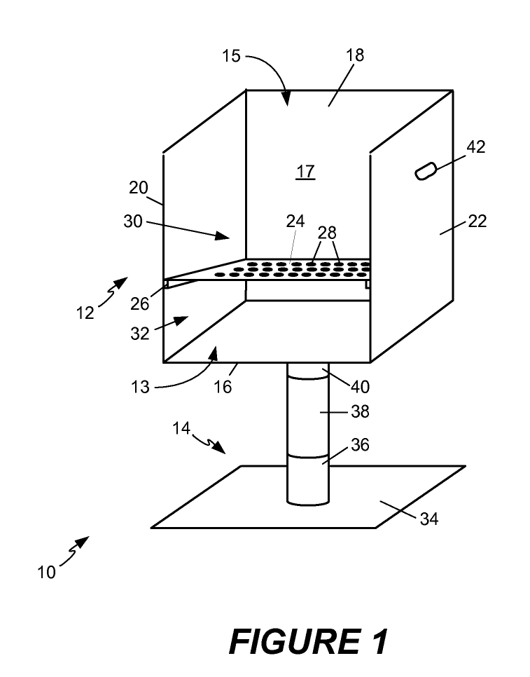

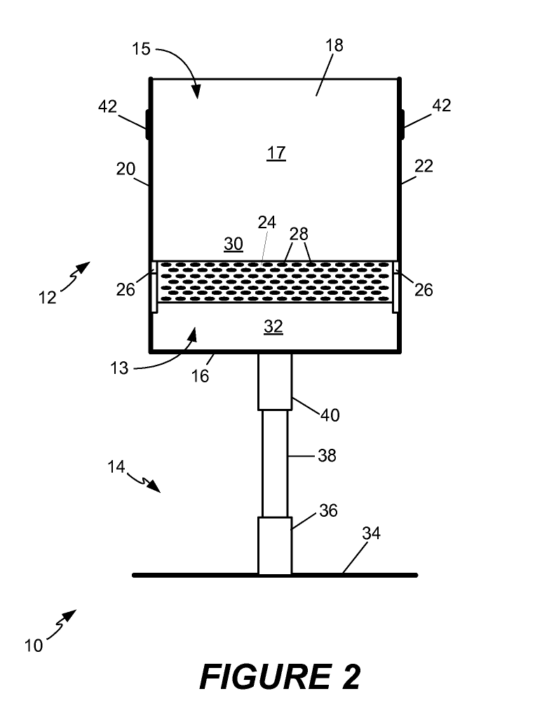

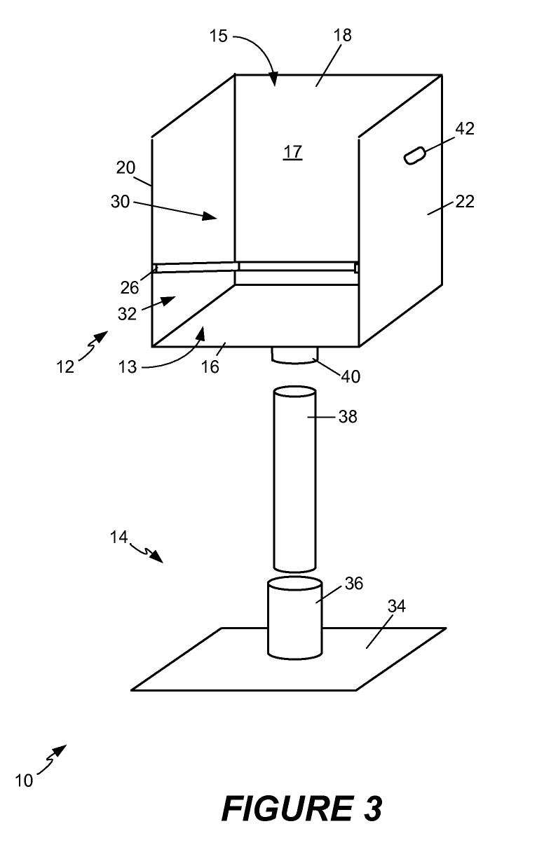

Referring now to FIGS. 1-4, a first cooking fuel preparation device 10 is shown. The cooking fuel preparation device 10 includes a metal enclosure 12 mounted to a base 14. The metal enclosure 12 includes a bottom 16, a rear 18, and left and right sides 20, 22, respectively. The metal enclosure 12 has an open front 13 and an open top 15, and forms an interior 17.

The metal enclosure can be constructed from any heat-resistant material, such as a steel plate, sheet metal, or other similar material. In one example embodiment, the bottom 16, rear 18, and left and right sides 20, 22 are constructed from 10 gauge steel plate (e.g., 0.1345 inch thick steel); however, other thicknesses of steel, and other metals, could be used as well. In certain embodiments, the metal enclosure 12 can also be coated with one or more heat-resistant or flame-resistant materials, such as a flame-resistant paint. Other coatings are possible as well.

The metal enclosure 12 can be any of a number of sizes. In certain embodiments, the metal enclosure 12 is approximately 14 inches wide by approximately 16 inches tall by approximately 18 inches deep. In still other embodiments, the metal enclosure 12 is approximately 9 inches wide by approximately 9 inches tall by approximately 12 inches deep. Other dimensions could be employed as well.

In the embodiment shown, within the interior 17, a grate 24 is positioned on a plurality of grate supports 26, which are mounted onto an interior side or one or more of the left and right sides 20, 22 and the rear 18 of the metal enclosure 12. In the embodiment shown, the grate 24 is substantially planar, and includes a plurality of apertures 28 therethrough.

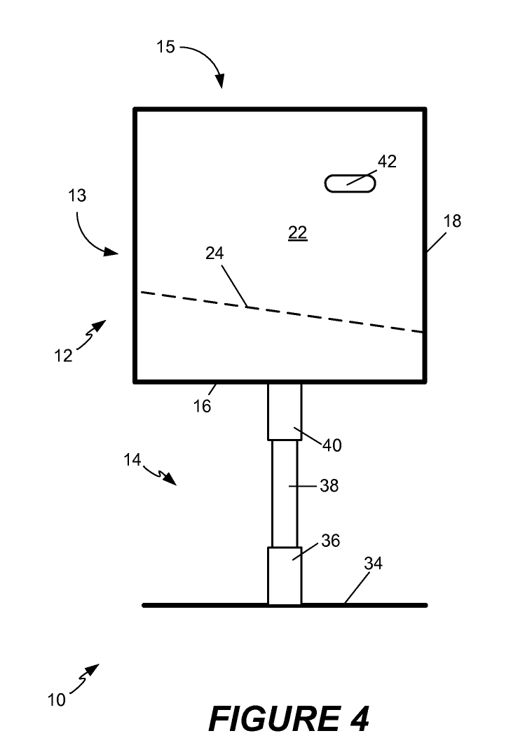

The grate 24 is preferably removable, and angled downwardly toward the rear 18 of the metal enclosure 12, separating an upper region 30 and a lower region 32 of the interior 17. In the embodiment shown, the grate supports 26 are angled (as best illustrated in FIGS. 1 and 4) such that, when the grate 24 is installed in the metal enclosure 12, a front edge of the grate sits approximately 1 to 2 inches higher within the metal enclosure than a rear edge of the grate. For example, in certain embodiments a front edge of the grate 24 can be positioned about 6 inches above the bottom 16 of the metal enclosure 12, and a rear edge of the grate 24 can be positioned about 4 inches above the bottom of the metal enclosure. This results in an angle formed between the front and back of the grate of approximately 5 to 20 degrees; however, in other embodiments, other angles could be used as well.

The base 14 can take a number of forms, but generally includes one or more supports extending downwardly from the metal enclosure 12. In the embodiment shown, the base 14 includes a pedestal formed from a base plate 34 and upwardly extending hollow cylinder 36. The hollow cylinder 36 is sized to receive a cylindrical extension 38, which can be inserted into the hollow cylinder 36. A complementary hollow cylinder 40 is mounted to an external side of the bottom 16, and also can receive the cylindrical extension 38.

The base plate 34 is sized to prevent the cooking fuel preparation device 10 from overturning in high winds, therefore allowing the device to be used in a variety of outdoor cooking situations. In some embodiments, the base plate 34 can be up to or exceeding about 16 inches wide by about 24 inches long (deep). Other sizes can be used as well. Additional features, such as stakes or other mechanisms for securely maintaining the device 10 upright could be incorporated into the base plate 34 as well.

In certain embodiments, the cylindrical extension 38 is a telescoping extension, allowing a user to customize a height at which the metal enclosure 12 resides above the base plate 34, and therefore above the ground. In some embodiments, the cylindrical extension 38 is a constant length of approximately 24 inches.

In use, a selected cooking fuel can be placed on the grate 24 within the metal enclosure 12 (i.e., within the upper region 30), and lit on fire. Various types of cooking fuel can be used, for example charcoal briquettes, wood logs, wood chips, fuel logs, or other natural or synthetic solid fuels. The cooking fuel is well ventilated because the open front 13 and lower region 32 cooperate to allow airflow below the cooking fuel, as well as above the cooking fuel (due at least in part to the open front 13 and open top 15).

When assembled, the metal enclosure 12 is horizontally rotatable relative to the base 14, allowing a user to control a direction in which the open front 13 of the metal enclosure faces. This allows the metal enclosure 12 to be rotated to allow the open front 13 to face the wind, providing adequate ventilation to light the fuel. When the fuel is lit and ready, the metal enclosure 12 can be rotated such that the open side is facing away from the wind, thereby protecting the fuel from unnecessarily fast burning.

As the cooking fuel resting in the upper region 30 becomes ready (i.e., all briquettes or wood pieces are evenly lit), the user can insert a shovel or other tool through the open front 13 to collect a desired amount of the cooking fuel, to be transferred to a barbecue grill, pit barbecue, or other outdoor cooking arrangement. Preferably, the user will retain at least a small amount, or seed, of lit cooking fuel within the metal enclosure 12, and add new unlit fuel to the upper region 30 to be lit by contact with that seed of lit cooking fuel (e.g., by rotating the metal enclosure such that the open front 13 faces an upwind direction and allowing for increased airflow within the interior 17 until lit, when it can be returned to a downwind orientation). In this manner, a user can repeatedly develop a supply of ready, lit cooking fuel that can be transferred to an outdoor cooking arrangement. Spent fuel, in the form of ash, will fall through the grate 24 into the lower region 32, and can be shoveled or otherwise removed from the metal enclosure 12 as necessary or desired.

Optionally one or more handles 42 are installed onto the metal enclosure 12 to assist in carrying and moving the metal enclosure in use, and rotating the metal enclosure 12 relative to the base plate 34. The metal hands 42 can be collapsible or stationarily mounted to the metal enclosure 12. The metal enclosure 12, grate 24, base plate 34, and cylindrical extension 38 are preferably capable of disassembly for convenience of travel.

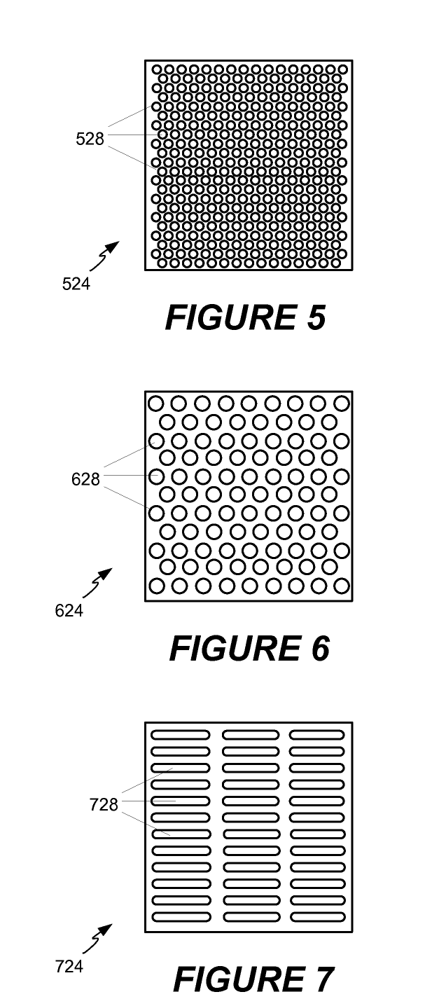

Referring now to FIGS. 5-7, in certain embodiments, the cooking fuel preparation device 10 can include a plurality of grates which are selectively installed into the metal enclosure (e.g., one at a time), and are selected for use with a particular cooking fuel. Each of the illustrated grates have generally the same width and length, and therefore are interchangeable for use as the grate 24 within the metal enclosure 12 of FIGS. 1-4. The grates illustrated in FIGS. 5-7 can have a variety of thicknesses, but in certain embodiments can be 10 gauge perforated steel plate having apertures extending therethrough.

FIG. 5 illustrates a first grate 524 having relatively small apertures 528, thereby adapted for use with small briquettes or other types of granular fuel. FIG. 6 illustrates a second possible grate 624 having larger apertures 628, for example for use with larger briquettes or wood logs used as cooking fuel. FIG. 7 illustrates a third example grate 724 having elongated apertures 728. Other shapes and sizes of apertures can be used as well (e.g., including a wire grate or other arrangement), depending upon the desired cooking fuel to be used in the cooking fuel preparation device 10.

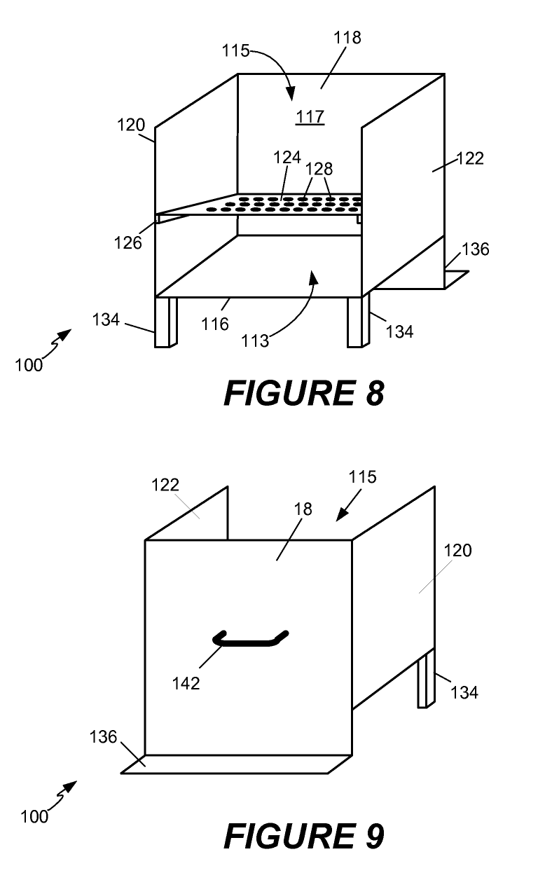

Referring now to FIGS. 8-10, a second example embodiment of a cooking fuel preparation device 100 is shown. The cooking fuel preparation device 100

Generally, the cooking fuel preparation device 100 is designed for lower volumes of cooking fuel as compared to the device 10 of FIGS. 1-4, and is therefore adapted toward smaller-scale outdoor cooking, such as at a home in a backyard grilling scenario.

The cooking fuel preparation device 100 includes a metal enclosure 112 and a base 114. The metal enclosure 112 includes a bottom 116, a rear 118, and left and right sides 120, 122, respectively. The metal enclosure 112 has an open front 113 and an open top 115, and forms an interior 117. The cooking fuel preparation device 100 can be made from analogous materials as the device 10 of FIGS. 1-4.

Although the metal enclosure 112 can take any of a number of sizes, it preferably can be at the lower end of the range of sizes indicated above, for example approximately 9 inches wide, 9 inches tall, and 12 inches deep. Other dimensions could be employed as well.

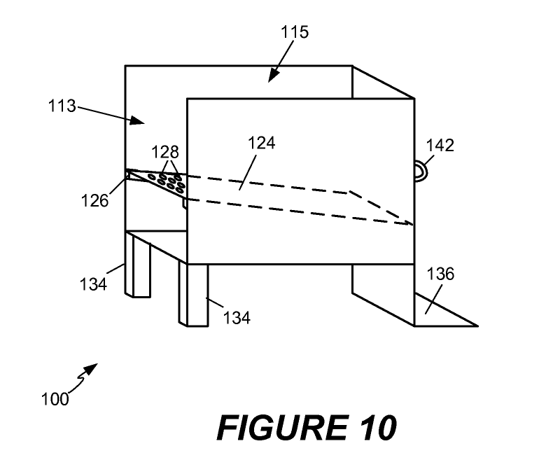

Also analogously to device 10 above, a grate 124 is positioned on a plurality of grate supports 126, and can include apertures 128 therethrough in any configuration as analogous to those in device 10. The grate 124 is preferably substantially planar and removable, and angled downwardly toward the rear 118 of the metal enclosure 112, analogously to device 10. The grate supports 126 are angled (as best illustrated in FIG. 10) such that, when the grate 124 is installed in the metal enclosure 112, a front edge of the grate sits approximately 1 to 2 inches higher within the metal enclosure than a rear edge of the grate. In an example embodiment, the front edge is 3½ inches above the bottom 116 of the metal enclosure 112, and the rear edge is 2 ½ inches above the bottom 116. Other arrangements are possible as well.

As compared to device 10 above, in the embodiment of FIGS. 8-10 the base 114 is formed from a plurality of legs 134 and a rear support plate 136, which optionally is formed integrally with the rear 118 of the metal enclosure 112. A handle 142 is mounted on the rear 118 of the metal enclosure, and can be used to manually readjust the position of the device 100 relative to the wind as necessary to maintain optimum lighting conditions for cooking fuel within the interior 117. The device 100 is used analogously to device 10 of FIGS. 1-4, but is not rotatable relative to the base, and therefore must be manually readjusted on the surface upon which it stands.

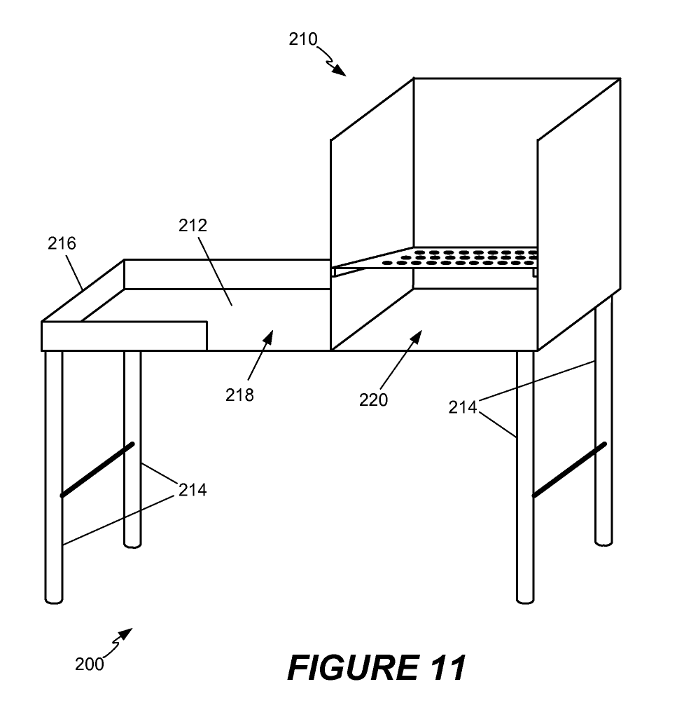

Referring now to FIG. 11, a dutch oven cooking table 200 is illustrated having a cooking fuel preparation device 210 integrated therewith, according to a possible embodiment of the present disclosure. In various embodiments, the cooking fuel preparation device 210 generally has analogous dimensions and features as cooking device 10 of FIGS. 1-4, but is mounted to a tabletop 212 on which a dutch oven can be placed. The tabletop 212 is supported by a plurality of table legs 214, and includes a ledge 216 extending upwardly substantially around a perimeter of the tabletop to retain cooking fuel (e.g. charcoal briquettes) on the table. The tabletop 212 can be any of a number of sizes. In the embodiment shown, the tabletop 212 is approximately 18 inches square (not including area taken by the cooking fuel preparation device 210), and the ledge is approximately 2 ½ inches high. These dimensions can vary widely depending upon the particular application to which the table is directed. Although in the embodiment shown the table legs 214 are approximately 23 inches long (with an optional support bar shown at approximately 8 inches high along the legs), different heights could be used as well. Optionally, an opening 218 in the perimeter proximate to an open front 220 of the cooking fuel preparation device 210 allows simple transfer of cooking fuel between the device 210 and the tabletop 212 for use.

Referring now to FIGS. 1-11 overall, it can be seen that, in use, the cooking fuel preparation devices of the present disclosure provide a number of advantages. For example, the cooking fuel preparation devices described herein are capable of receiving various types of fuels (wood and charcoal). Additionally, the cooking fuel preparation devices described herein can be used to retain a fuel “seed” such that an individual grilling outdoors can prepare a large amount of fuel for use, transfer that fuel to grilling equipment, and then add additional fuel to a set of existing lit seed fuel items, allowing for reuse of the cooking fuel preparation device without requiring re-lighting of the fuel in the metal enclosure. This avoids unnecessary, repeated use of paper or liquid starter materials which can have a detrimental effect on cooking outcomes (i.e., flavor). Other advantages of the cooking fuel preparation devices described herein exist as well.

The above specification, examples and data provide a complete description of the manufacture and use of the composition of the invention. Since many embodiments of the invention can be made without departing from the spirit and scope of the invention, the invention resides in the claims hereinafter appended.

1. A cooking fuel preparation device comprising:
(a) a metal enclosure having a bottom, a rear, left and right sides, an open front and an open top, the metal enclosure forming an interior;
(b) a base attached to the metal enclosure, the base including at least one support;
(c) one or more grate supports mounted to at least the left and right sides within the interior; and
(d) a substantially planar grate positioned on the one or more grate supports and having a plurality of apertures therethrough, the grate angled downwardly toward the rear of the metal enclosure and forming an upper cooking fuel preparation region and a lower ventilation region within the interior volume.

2. The cooking fuel preparation device of claim 1, wherein the metal enclosure is pivotally attached to the base.

3. The cooking fuel preparation device of claim 1, wherein the base comprises a stand tube and a base plate having a cylindrical support extending upward therefrom, and wherein the metal enclosure includes a second cylindrical support mounted to the bottom of the metal enclosure.

4. The cooking fuel preparation device of claim 1, wherein the base comprises a plurality of legs affixed approximately at corners of the bottom side.

5. The cooking fuel preparation device of claim 1, wherein open front has a width sized to receive a shovel into the interior of the metal enclosure.

6. The cooking fuel preparation device of claim 1, wherein the grate is removably mounted within the interior of the enclosure.

7. The cooking fuel preparation device of claim 1, wherein the plurality of apertures in the grate are a generally uniform size.

8. The cooking fuel preparation device of claim 7, further comprising a second grate having a plurality of apertures therethrough and capable of use in replacement for the grate, and wherein the plurality of apertures in the second grate have a different size than the plurality of apertures in the grate, thereby accommodating a different type of cooking fuel.

9. The cooking fuel preparation device of claim 1, wherein the metal enclosure has a width of between approximately 9 and 14 inches, a height between approximately 9 and 16 inches, and a depth between approximately 12 and 18 inches.

10. The cooking fuel preparation device of claim 9, wherein the metal enclosure has a width of approximately 9 inches, a height of approximately 9 inches, and a depth of approximately 12 inches.

11. The cooking fuel preparation device of claim 9, wherein the metal enclosure has a width of approximately 14 inches, a height of approximately 16 inches, and a depth of approximately 18 inches.

12. The cooking fuel preparation device of claim 1, wherein the grate is angled within the interior of the metal enclosure such that a front edge of the grate is positioned between one inch and two inches above a rear edge of the grate.

13. The cooking fuel preparation device of claim 1, further comprising a plurality of grates, each of the plurality of grates sized to be positioned on the one or more grate supports within the interior of the metal enclosure.

14. The cooking fuel preparation device of claim 1, further comprising at least one handle mounted to an exterior of the metal enclosure.

15. The cooking fuel preparation device of claim 1, further comprising a cooking table onto which the metal enclosure is mounted, the cooking table sized to support a dutch oven.

16. The cooking fuel preparation device of claim 15, wherein the cooking table

17. A method of preparing cooking fuel using a cooking fuel preparation device, the method comprising:
placing cooking fuel onto a grate positioned within a metal enclosure, the metal enclosure having a bottom, a rear, left and right sides, an open front and an open top, the metal enclosure forming an interior, the grate separating the interior of the metal enclosure into an upper cooking fuel preparation region and a lower ventilation region;
facing the open front in an upwind direction and lighting the cooking fuel; and
turning the metal enclosure to face the open front in an at least partially downwind direction, thereby controlling a supply of oxygen to the lit cooking fuel in the upper cooking fuel preparation region.

18. The method of claim 16, further comprising transferring at least a portion of the lit cooking fuel to a cooking apparatus.

19. A cooking fuel preparation device comprising:
(a) a metal enclosure having a bottom, a rear, left and right sides, an open front and an open top, the metal enclosure forming an interior;
(b) a base attached to the metal enclosure, the base including a stand tube and a base plate having a cylindrical support extending upward therefrom, and wherein the metal enclosure is pivotally attached to the stand tube by a second cylindrical support mounted to the bottom of the metal enclosure;
(c) one or more grate supports mounted to at least the left and right sides within the interior; and
(d) a substantially planar grate positioned on the one or more grate supports and having a plurality of apertures therethrough, the grate angled downwardly toward the rear of the metal enclosure and forming an upper cooking fuel preparation region and a lower ventilation region within the interior volume, wherein the grate is angled within the interior of the metal enclosure such that a front edge of the grate is positioned between one inch and two inches above a rear edge of the grate
(e) at least one handle mounted to an exterior of the metal enclosure.

20. The cooking fuel preparation container of claim 19, further comprising a plurality of grates, each of the plurality of grates sized to be positioned on the one or more grate supports within the interior of the metal enclosure and having different sizes of apertures such that each of the plurality of grates is adapted for use with a different type of cooking fuel.
